(19) United States
(12) Patent Application Publication
(10) Pub. No.: US 2005/0130703 A1
(43) Pub. Date: Jun. 16, 2005

(54) Mobile terminal displaying TV image on both main and sub display units

(75) Inventors: Dong-Uk Min, Seocho-Gu (KR); Kun-Pil Jung, Seocho-Gu (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC., Seocho-Gu (KR)

(21) Appl. No.: 11/010,626

(22) Filed: Dec. 14, 2004

(30) Foreign Application Priority Data
Dec. 16, 2003 (KR) 10-2003-0091971
Dec. 29, 2003 (KR) 10-2003-0098909

(51) Int. Cl. H04Q 7/20

(52) U.S. Cl. 455/556.1; 455/556.2

(57) ABSTRACT

Disclosed herein is a mobile terminal capable of receiving TV signals over the air. The mobile terminal includes main and sub display units for displaying operating states, a TV receiver unit for recovering an image signal from a TV signal received over the air, and a signal processor unit for outputting the image signal from the TV receiver to the main display unit and the sub display unit selectively or simultaneously. The mobile terminal may further include a flip open/close detector for detecting whether a flip is opened or closed and outputting a flip open/close detection signal, and a phone control unit for controlling the signal processor unit to output the image signal to the sub display unit located on the outer surface of the flip when the flip open/close detection signal indicates that the flip is closed.

### BACKGROUND OF THE INVENTION

1. Field of the Invention

The present invention relates to a mobile terminal and, more particularly, to a mobile terminal capable of receiving TV signals.

2. Description of the Related Art

Technologies for mobile terminals have been rapidly developed along with the increased use of mobile terminals. Various features have been added to mobile terminals to meet consumers' demand.

Mobile terminals equipped with a camera have gained wide popularity. Recently, mobile terminals equipped with a TV tuner have been also put on the market. As memory capacity available in the mobile terminals increases, such useful features make the mobile terminals almost the same as effective personal multimedia devices.

A flip-type TV phone capable of receiving TV signals allows a user to watch TV through a main display unit on the inner surface of the flip. However, when the flip is closed, the user cannot watch TV using the phone. In addition, while the user is watching TV using the phone, the user cannot efficiently take advantage of a sub display unit on the outer surface of the flip.

Further, since the TV phone does not allow the user to watch two channels simultaneously, the user stops watching a current channel to tune in to a different channel.

Implementing the above-mentioned features incorporated in the mobile terminal require not only the sufficient amount of space available in the mobile terminal but also an efficient system architecture for properly controlling components in the mobile terminal. In addition, designing a new system architecture each time new features are added to the mobile terminal is very inefficient in terms of cost and time.

### SUMMARY OF THE INVENTION

The present invention provides a mobile terminal allowing a user to watch TV when the mobile terminal's flip is closed.

The present invention also provides a mobile terminal allowing a user to watch TV on its main and sub display units.

The present invention also provides a mobile terminal allowing a user to watch different channels simultaneously on its main and sub display units.

The present invention also provides a system architecture that efficiently operates in a mobile terminal capable of receiving TV signals.

The present invention also provides a system architecture that makes it possible to systematically control components in a mobile terminal and is easy to design when adding new modules to the mobile terminal.

In accordance with an aspect of the present invention, there is provided a mobile terminal comprising: main and sub display units for displaying operating states; a TV receiver unit for recovering an image signal from a TV signal received over the air; and a signal processor unit for outputting the image signal from the TV receiver unit to the main display unit and the sub display unit selectively or simultaneously.

The mobile terminal may further comprise a flip open/close detector for detecting whether a flip is opened or closed and outputting a flip open/close detection signal; and a phone control unit for controlling the signal processor unit to output the image signal to the sub display unit located on the outer surface of the flip when the flip open/close detection signal indicates that the flip is closed.

The signal processor unit may comprise an image processor for scaling an image signal output from the TV receiver unit and outputting the scaled image signal to the sub display unit.

The TV receiver unit may comprise: a tuner for demodulating a wireless broadcast signal received via an antenna; and a decoder for decoding the demodulated wireless broadcast signal into digital data and outputting the digital data to the signal processor unit.

The signal processor unit may control the operation of the TV receiver unit through a serial bus.

The TV receiver unit may comprise first and second tuners, and the signal processor unit may comprise a first image output portion for outputting an image signal output from the first tuner to the main display unit, and a second image output portion for outputting an image signal output from the second tuner to the sub display unit.

The signal processor unit may further comprise an image processor for scaling an image signal output from the TV receiver unit and outputting the scaled image signal to the second image output portion.

The mobile terminal may further comprise a system controller for controlling the signal processor unit to interchange respective images on two channels being currently displayed on the main and sub display units according to an instruction inputted through a keypad.

The mobile terminal may further comprise a system controller for controlling the TV receiver unit to tune in to first and second channels in a time division manner so that the TV receiver unit alternately outputs image signals on the first and second channels, wherein the signal processor unit may comprise: a first image output portion for outputting an image signal on the first channel outputted from the TV receiver unit to the main display unit; and a second image output portion for outputting an image signal on the second channel outputted from the TV receiver unit to the sub display unit.

### BRIEF DESCRIPTION OF THE DRAWINGS

The above and other features and advantages of the present invention will become more apparent by describing in detail exemplary embodiments thereof with reference to the accompanying drawings, in which:

FIG. 1 is a block diagram showing a mobile terminal in accordance with an embodiment of the present invention;

FIG. 2 is a more detailed block diagram of the mobile terminal shown in FIG. 1;

FIG. 3 is a block diagram showing a main part of the mobile terminal shown in FIG. 1 in accordance with another embodiment of the present invention;

FIG. 4 is a block diagram showing a main part of the mobile terminal shown in FIG. 1 in accordance with another embodiment of the present invention;

FIG. 5 is a block diagram showing the tuner of FIG. 2 in accordance with the present invention; and

FIG. 6 is a flowchart showing a method of controlling the mobile terminal shown in FIG. 3.

### DESCRIPTION OF THE PREFERRED EMBODIMENTS

Exemplary embodiments of the present invention will now be described in detail with reference to the accompanying drawings so that those skilled in the art can easily understand and carry out the present invention.

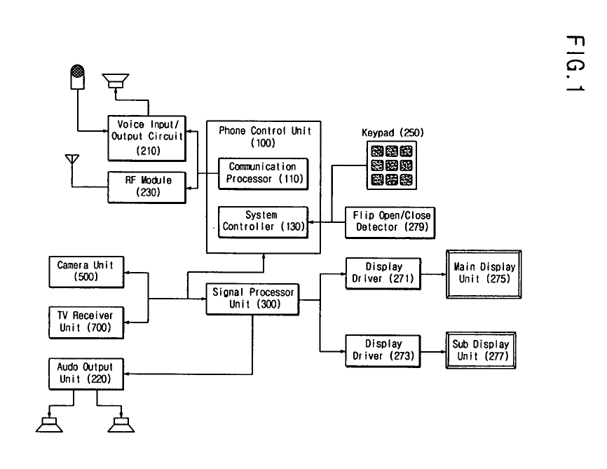

FIG. 1 is a block diagram showing a mobile terminal in accordance with an embodiment of the present invention. The mobile terminal comprises a phone control unit 100 and associated circuits, which are common to the conventional mobile terminal, a camera unit 500, a TV receiver unit 700, and a signal processor unit 300. The camera unit 500 is optional in the present invention.

The associated circuits include a keypad 250 for inputting operating instructions, main and sub display units 275 and 277 for displaying menus and operating states, a radio frequency (RF) module 230 for extracting voice and data signals from radio signals transmitted/received via an antenna, and an voice input/output circuit 210 for receiving/outputting a voice communication signal from the RF module 230 via a microphone and a speaker.

A flip-type mobile terminal has two displays: a large main display unit 275 facing inwards and a smaller sub display unit 277 that faces outwards and is used to display basic information when the phone is closed. Each of these displays typically consists of a glass liquid crystal display (LCD) panel on which the image is shown. The display units 275 and 277 are driven by display drivers 271 and 273, respectively. The RF module 230 includes an antenna and an RF circuit to communicate with base stations. In the present invention, the RF module 230 is designed to be available in all types of cellular systems such as TDMA, CDMA, PDC, and GSM. The voice I/O circuit 210, which comprises well-known circuits such as an audio amplifier and a filter, converts digital into analog voice signals and vice versa.

A baseband circuit in the RF module 230 and most circuits in the phone control unit 100 are integrated into a commercially available single chip.

This IC chip, which is usually called a mobile station modem (MSM) chip, includes a hardware dedicated for communication processing, a digital signal processor, and a general-purpose microprocessor. Logically, the IC chip includes a communication processor 110 for processing voice and data communications, and a system controller 130 for controlling the overall system according to operating states or signals inputted from the keypad 250.

In accordance with a preferred embodiment of the present invention, the mobile terminal includes the TV receiver unit 700 for recovering an image signal from a TV signal received over the air, and the signal processor unit 300 for transferring the image signal output from the TV receiver unit 700 to the main display unit 275, the sub display unit 277, or both of the display units 275 and 277. A flip-type mobile terminal displays a received image signal on the main display unit 275 when it is opened, and displays on the sub display unit 277 when it is closed. Alternatively, when it is opened, the flip-type mobile terminal displays a received image signal on both main and sub display units 275 and 277.

In addition, an audio signal of the TV signal demodulated by the TV receiver unit 700 may be directly output through an audio output unit 220. The audio output unit 220 outputs various audio signals, such as a bell sound signal and a sound source signal, separately or in a mixed manner.

In accordance with another preferred embodiment of the present invention, the mobile terminal may further include the camera unit 500 for converting an optical signal received from a lens system into an electric signal and outputting the electric signal to the signal processor unit 300. The TV receiver unit 700 and the camera unit 500 are configured to output an image signal of the same format, i.e., data of 8-bit YUV format, which is in turn processed selectively in the signal processor unit 300.

In accordance with another preferred embodiment of the present invention, the mobile terminal further includes a flip open/close detector 279 for detecting whether the flip is closed or opened and outputting a signal indicating whether the flip is opened or closed, and the phone control unit 100 for controlling the signal processor unit 300 to output image signals to the sub display unit 277 when the flip open/close signal indicates that the flip is closed. The flip open/close detector 279 uses a well-known mechanical, magnetic, or optical contact. Consequently, the flip-type mobile terminal can display the received image signal on the main display unit 275 when the flip is opened, and on the sub display unit 277 when the flip is closed.

In accordance with another preferred embodiment of the present invention, the TV receiver unit 700 includes two tuners. The signal processor unit 300 outputs one of two image signals received through the tuners to the main display unit 275 and outputs the other to the sub display unit 277.

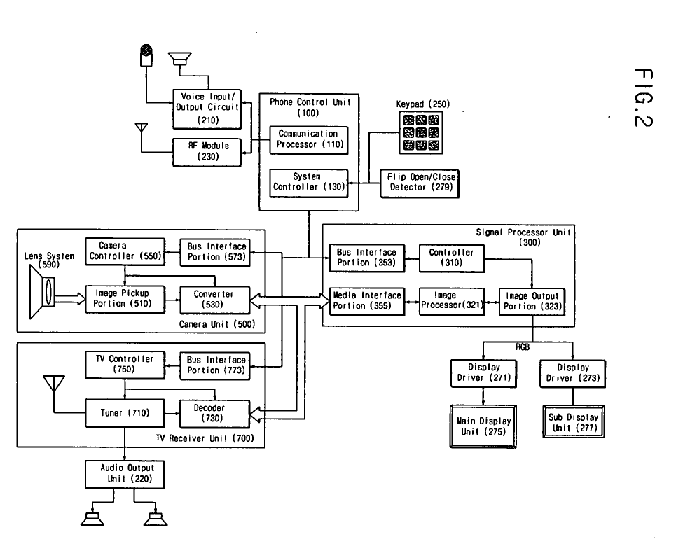

In accordance with another preferred embodiment of the present invention, the TV receiver unit 700 includes a single tuner. The system controller 130 allows the tuner to tune in to two different channels in a time division manner, thereby acquiring image signals from the time-divided channels. The signal processor unit 300 outputs one of the acquired image signals to the main display unit 275 and outputs the other to the sub display unit 277. The above-mentioned embodiments of the present invention will now be described in detail with reference to FIG. 2.

FIG. 2 is a more detailed block diagram of the mobile terminal shown in FIG. 1. The camera unit 500 converts an optical signal received through a lens system into an electrical signal. The TV receiver unit 700 extracts an image signal from a TV signal received over the air.

The signal processor unit 300, which was developed for signal processing in a camera phone by the present applicant, can also be applied to the TV receiver unit 700 without alteration. In addition, the signal processor unit 300 used for the camera unit 500 can be shared by the TV receiver unit 700 without the need to provide an additional signal processing module to be used for the TV receiver unit 700. The signal processor unit 300 selectively processes a first image signal outputted from the camera unit 500 and a second image signal outputted from the TV receiver unit 700, and outputs the processed image signal to the main display unit 275 or the sub display unit 277.

In accordance with another preferred embodiment of the present invention, the signal processor unit 300 selectively activates the camera unit 500 and the TV receiver unit 700 using chip select logic. The system controller 130 provided in the phone control unit 100 instructs the signal processor unit 300 to capture an image through the camera unit 500 or to receive a TV signal through the TV receiver unit 700. In response to this instruction, the signal processor unit 300 selectively controls the camera unit 500 and the TV receiver unit 700.

In accordance with another preferred embodiment of the present invention, the signal processor unit 300 controls the operations of the camera unit 500 and the TV receiver unit 700 through a serial bus. An I²C bus is an example of the serial bus. The I²C bus, also called an “Inter-IC bus”, is a serial bus developed by Philips Electronics and a two-wire, bidirectional serial bus that provides a serial data line and a serial clock line interface to exchange information between devices.

In accordance with another preferred embodiment, the camera unit 500 includes a lens system 590, an image pickup portion 510 for converting an optical signal received from the lens system 590 into an analog electric signal, a converter 530 for converting the analog signal outputted from the image pickup portion 510 into a digital signal and outputting the digital signal in a format suitable for the signal processor unit 300, and a camera controller 550 for controlling the overall operation of the camera unit 500.

The lens system 590, composed of one or more small lenses, focuses and provides light to the image pickup portion 510. The image pickup portion 510, which typically includes a complementary metal-oxide-semiconductor (CMOS) or charge coupled device (CCD) image sensor, is a well-known component used for converting light into electric signals in each pixel and sequentially outputting the converted electric signals in synchronization with clocks. The converter 530 converts a current or voltage value proportional to the brightness of an image, which is output from the image pickup portion 510, into a digital signal, which is in turn transformed into a YUV format. Alternatively, the converter 530 may further include a codec for compressing the pickup image into a Joint Photographic Experts Group (JPEG) or Motion Picture Experts Group (MPEG) format.

In the present invention, an image signal processed in the mobile terminal has a single format, e.g., YUV format in an embodiment. That is, image processing modules transform signals into a YUV format. The camera controller 550 controls the operation of the camera unit 500 according to instructions from the external devices. The camera controller 550 may be implemented with a microprocessor or digital logic circuit. An interface with the external devices will be described in detail later.

In an embodiment, the TV receiver unit 700 includes an antenna for receiving radio signals, a tuner 710 for demodulating broadcast signals received via the antenna, a decoder 730 for decoding the demodulated broadcast signals into digital data, and a TV controller 750 for controlling the operation of the TV receiver unit 700 according to control instruction signals from the external devices. The antenna may be provided separately from an antenna for mobile communications. Alternatively, a micro-strip patch antenna may be shared for both TV reception and mobile communications.

The tuner 710 may be a typical tuner which supports National Television System Committee (NTSC) broadcast system or Phase Alternation by Line (PAL) broadcast system, or a tuner commonly available in all of them. In another embodiment, the tuner 710 may be a tuner which supports multimedia broadcast for mobile communications, such as wireless local area network (LAN) based multimedia broadcast or satellite based digital multimedia broadcast (DMB).

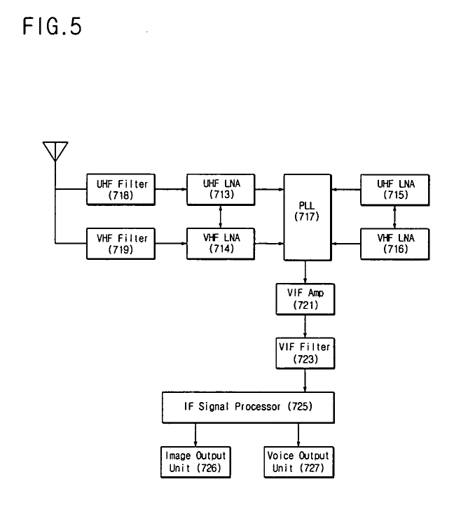

FIG. 5 is a block diagram showing the tuner 710 in accordance with the present invention. A wireless broadcast signal received from the antenna is divided into an ultra high frequency (UHF) band signal and a very high frequency (VHF) band signal by means of a UHF filter 718 and a VHF filter 719. The UHF and VHF band signals are filtered through low noise amplifiers (LNAs) 728 and 729, respectively. The filtered signals are sent to a phase-locked loop (PLL) 717 to be mixed with local oscillation frequencies, whereby the signals are demodulated. The PLL 717 receives an intermediate frequency (IF) for each of the band signals from each of UHF and VHF voltage-controlled oscillators (VCOs) 715 and 716. The oscillation frequency of each of the UHF VCO and VHF VCO 715 and 716 is controlled by the TV controller 750 shown in FIG. 2. The demodulated signal is demodulated once again by an IF signal processor 725 into analog image and audio signals, which are in turn outputted to image and voice output units 726 and 727, respectively. The IF signal processor 725 is controlled by the TV controller 750 shown in FIG. 2. An output level (i.e., volume) of the voice output unit 727 is also controlled by the TV controller 750 shown in FIG. 2.

In an embodiment, the decoder 730 transforms an analog image signal outputted from the image output portion 726 into a digital YUV signal. The operation of the decoder 730 is controlled by the TV controller 750.

In an embodiment, the signal processor unit 300 includes a media interface portion 355 for selectively receiving first and second image signals, an image processor 321 for processing an image signal received from the media interface portion 355, a image output portion 323 for converting the image signal processed by the image processor 321 into display data and outputting the display data, a bus interface portion 353 for controlling the operations of the camera unit 500 and the TV receiver unit 700, and a controller 310 for controlling the overall operation of the signal processor unit 300 and the external devices.

The media interface portion 355 receives and buffers 8-bit YUV format image data into an internal memory. The image processor 321 converts an interlaced-scan signal into a progressive scan signal, which is in turn scaled through interpolation and/or decimation to suit the resolution of the display 275 or 277. The image processor 321 further includes a codec for storing image data or decompressing the image data. In an embodiment, the codec includes an MPEG encoder/decoder, and a JPEG encoder/decoder for compressing a captured image frame into a still image, storing and reading the still image. The MPEG encoder/decoder and the JPEG encoder/decoder are implemented with a DSP and a core. The image processor 321 may further include circuits for enhancing definition and adjusting brightness/contrast. In addition, the image processor 321 may include filters for providing graphic effects.

In an embodiment, the image output portion 323 receives image data from the image processor 321 or directly from the media interface portion 355, and outputs the image data in 16-bit RGB format to the display 275 or 277.

A detailed description will now be given of how the signal processor unit 300 controls the camera unit 500 and TV receiver unit 700 in media signal processing with reference to FIG. 2.

In accordance with another preferred embodiment of the present invention, the camera unit 500 includes a bus interface portion 573 for receiving a serial bus control signal from the signal processor unit 300, and a camera controller 550 for controlling the overall operation of the camera unit 500 according to control signals received from the bus interface portion 573.

In accordance with another preferred embodiment of the present invention, the TV receiver unit 700 includes a bus interface portion 773 for receiving a serial bus control signal from the signal processor unit 300, and a TV controller 750 for controlling the overall operation of the TV receiver unit 700 according to control signals received from the bus interface portion 773.

In accordance with another preferred embodiment of the present invention, the signal processor unit 300 includes a media interface portion 355 for selectively receiving a first image signal from the camera unit 500 and a second image signal from the TV receiver unit 700, a bus interface portion 353 for controlling the operations of the camera unit 500 and the TV receiver unit 700, and a controller 310 for controlling external devices through the bus interface portion 353.

In accordance with another preferred embodiment of the present invention, the controller 310 provided in the signal processor unit 300 controls the bus interface portion 353 to individually access the tuner 710 and the decoder 730 provided in the TV receiver unit 700 by assigning a plurality of addresses.

When the signal processor unit 300 selects the camera unit 500 or the TV receiver unit 700 through chip select logic, the controller 310 controls the operation of the camera unit 300 or TV receiver unit 700 through the bus interface portion 353. In an embodiment, the bus interface portions 353, 573 and 773 use an I²C bus for communications. In an embodiment, addresses are individually allocated to each of the operations of the camera unit 500 such as image capturing, brightness adjusting, and resolution setting operations. Addresses are individually allocated to each of the operations of the TV receiver unit 700 such as channel selecting, audio output level adjusting, and decoding operations. The controller 310 controls the operations of the camera unit 500, such as image capturing, brightness adjusting, and resolution setting operations, by writing control instructions into the addresses allocated to the operations of the camera unit 500 through the bus interface portion 353. In addition, the controller 310 can control the operations of the TV receiver unit 700, such as TV channel changing, volume adjusting, and image format changing operations, by writing control instructions into the addresses allocated to the operations of the TV receiver unit 700 through the bus interface portion 353.

Image signals outputted from the camera unit 500 through the converter 530 and from the TV receiver unit 700 through the decoder 730 have 8-bit YUV format in common. Thus, the image signals input to the signal processor unit 300 through the media interface portion 355 can be processed by the image processor 321 and the image output portion 323.

In accordance with another preferred embodiment of the present invention, the mobile terminal outputs an image signal from the TV receiver unit 700 to the main display unit 275 and the sub display unit 277 selectively or simultaneously. A more detailed description will be given of how the signal processor unit 300 operates according to this embodiment of the present invention.

In accordance with another preferred embodiment of the present invention, the mobile terminal further includes a flip open/close detector 279 for detecting whether the flip is opened or closed and outputting a flip open/close detection signal, and the phone control unit 100 for controlling the signal processor unit 300 to output image signals to the sub display unit 277 when the flip open/close detection signal indicates that the flip is closed. When a user selects a TV mode and a desired TV channel with the flip opened, the system controller 130 instructs, through the I²C bus, the signal processor unit 300 to allow the selected channel to be viewed. The signal processor unit 300 receives the instruction through the bus interface portion 353 and the controller 310 operates according to the instruction. On the other hand, the controller 310 switches the bus interface portion 353 from I²C slave mode to I²C host mode, and then instructs the TV receiver unit 700 to tune in to the selected channel. The TV receiver unit 700 receives this instruction through the bus interface portion 773. The TV controller 750 controls, according to the instruction, the UHF and VHF VCOs 715 and 716 and the IF signal processor 725 provided in the tuner 710 to tune in to the selected channel and demodulate a TV broadcast signal on the selected channel into an image signal. The decoder 730 decodes the demodulated image signal into a digital YUV signal.

The digital YUV signal is input to the media interface portion 355 in the signal processor unit 300. The image processor 321 converts an interlaced-scan image signal inputted under the control of the controller 310 into a progressive scan image signal, which is in turn scaled through interpolation and/or decimation to suit the resolution of the main display unit 275. The scaled image signal is selectively subjected to brightness/contrast adjustment, image quality enhancement, etc., and is output from the image processor 321 to the image output portion 323. The image output portion 323 converts the image signal received from the image processor 321 into an image signal with 16-bit RGB format suitable for input to the main display unit 275, and provides the 16-bit RGB image signal to the main display unit 275. The image output portion 323 sequentially records display data in a display memory provided in the display driver 271 through a 16-bit parallel bus, thereby allowing the image to be displayed on the main display unit 275.

On the other hand, when the flip is closed, the system controller 130 instructs the signal processor unit 300, via the I²C bus, to output the display data to the sub display unit 277. The signal processor unit 300 receives this instruction through the bus interface portion 353, and the controller 310 operates according to the instruction. The TV receiver unit 700 performs the subsequent operations in the same manner as described above.

A signal output from the TV receiver unit 700 is input to the media interface portion 355 in the signal processor unit 300 through the bus. The image processor 321 converts an interlaced-scan image signal inputted under the control of the controller 310 into a progressive scan image signal, which is in turn scaled through interpolation and/or decimation to suit the resolution of the sub display unit 277. The scaled image signal is selectively subjected to brightness/contrast adjustment, image quality enhancement, etc. and then output from the image processor 321 to the image output portion 323. The image processor 321 includes a frame memory for storing one or more frames. This image processing technique is well-known in the art and a detailed description thereof is thus omitted herein.

The image output portion 323 converts the image signal received from the image processor 321 into 16-bit RGB format suitable for input to the sub display unit 277, and provides the 16-bit RGB image signal to the sub display unit 277. The image output portion 323 sequentially records display data in a display memory provided in the display driver 273 through a 16-bit parallel bus, thereby allowing the image to be displayed on the sub display unit 277.

The image output portion 323 can distinguish the display drivers 271 and 273 from each other through a memory map, or can distinguish the main and sub display units from each other through chip select logic.

Another embodiment of the present invention will now be described with reference to FIG. 2, in which an image is simultaneously displayed on both main and sub display units 275 and 277 regardless of whether the flip is opened or closed.

When a user sequentially selects a TV mode and a desired TV channel with the flip opened, the system controller 130 instructs, through the I²C bus, the signal processor unit 300 to allow the selected channel to be viewed. The signal processor unit 300 operates according to this instruction. On the other hand, the controller 310 switches the bus interface portion 353 from I²C slave mode to I²C host mode, and then instructs the TV receiver unit 700 to tune in to the selected channel. Next, the TV receiver unit 700 operates in the same manner as in the above-mentioned embodiment. The decoder 730 decodes the demodulated image signal into a digital YUV signal.

The digital YUV signal is input to the image processor 310 in the signal processor unit 300 through the bus. The image processor 321 converts an interlaced-scan image signal inputted under the control of the controller 310 into a progressive scan image signal, which is subjected to brightness/contrast and definition adjustments, etc. Subsequently, the image signal is scaled by the image processor 321 to suit the resolution of the main display unit 275 and is output to the display driver 271. Next, the image signal is scaled by the image processor 321 to suit the resolution of the sub display unit 277 and is output to the display driver 273. For instance, in the case when the resolution of the main display unit 275 is a multiple of the resolution of the sub display unit 277, the above-mentioned scaling operation can be implemented simply by skipping addresses in reading data from the memory.

In accordance with another preferred embodiment of the present invention, an image signal received from the TV receiver unit 700 is buffered into the media interface portion 355, and the image processor 321 controls the image output portion 323 to display the same frame once on each of the main display unit 275 and the sub display unit 277. Displaying the same frame once on each of the display units 275 and 277 is performed within a time corresponding to one frame, e.g., within 1/30 second in the NTSC system, whereby images are naturally displayed on both main and sub display units 275 and 277.

The present invention is not limited to this embodiment. For instance, images may be displayed on both the main and sub display units 275 and 277 by allocating more frames to the main display unit 275 than the sub display unit 277.

In a preferred embodiment of the present invention where an image is simultaneously displayed on the main and sub display units 275 and 277, in response to an instruction from the keypad 250, the system controller 130 controls the image processor 321 to perform a vertical image reversal process on an image outputted to the sub display unit 277 so that a vertically reversed image is displayed on the sub display unit 277. Accordingly, a user can view an image through the main display unit 275, while another user can view the image through the sub display unit 277.

The TV receiver unit 700 performs the subsequent operations in the same manner as described above. The image output portion 323 converts the image signal received from the image processor 321 into 16-bit RGB format suitable for input to the main and display units 275 and 277, and sequentially writes the 16-bit RGB image signals into the display memories in the display drivers 271 and 273.

The image output portion 323 can distinguish the display drivers 271 and 273 from each other through a memory map, or can distinguish the main and sub display units 275 and 277 from each other through chip select logic.

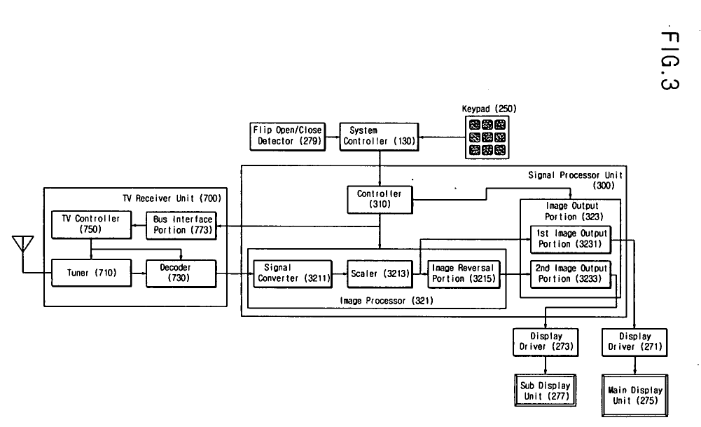

FIG. 3 is a block diagram showing a main part of the mobile terminal shown in FIG. 1 in accordance with another embodiment of the present invention. Although some of components shown in FIG. 1 have not been shown in FIG. 3, a description thereof is not deemed necessary for an understanding of the present embodiment.

The system controller 130 tunes the TV receiver unit 700 to two channels in a time division manner so that the TV receiver unit 700 alternately outputs image signals in the channels. The image output portion 323 includes a first image output portion 3231 for transferring the image signal in the first channel output from the TV receiver unit 700 to the main display unit 275, and a second image output portion 3233 for transferring the image signal in the second channel output from the TV receiver unit 700 to the sub display unit 277.

In accordance with another preferred embodiment of the present invention, the signal processor unit 300 further includes an image processor 321 for scaling an image signal output from the TV receiver unit 700 and transferring the scaled image signal to the second image output portion 3233.

In accordance with another preferred embodiment of the present invention, the system controller 130 controls the signal processor unit 300 to interchange images on the channels currently displayed on the main and sub display units 275 and 277 according to an instruction inputted through the keypad.

In accordance with another preferred embodiment of the present invention, the signal processor unit 300 controls the operation of the TV receiver unit 700 via a serial bus.

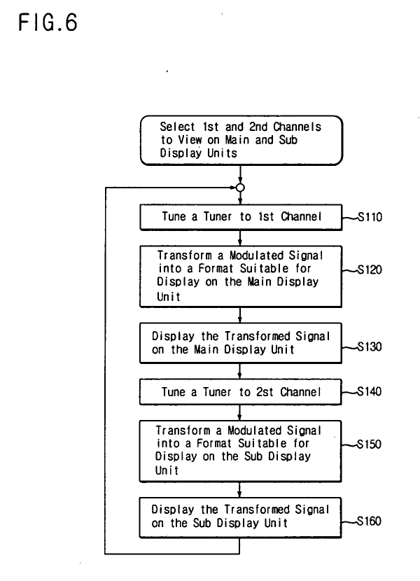

A more detailed description will now be given of how the signal processor unit 300 operates according to an embodiment of the present invention. FIG. 6 is a flowchart showing how the mobile terminal shown in FIG. 3 operates to play a plurality of channels.

First, when a user selects a TV mode and two channels to view on the main and sub display units 275 and 277 while the flip is opened, the system controller 130 instructs the signal processor unit 300 through the I²C bus to play the selected channels. The signal processor unit 300 receives this instruction through the bus interface portion 353, and the controller 310 operates according to the instruction.

After switching to I²C host mode, the controller 310 instructs the TV receiver unit 700 to tune in to the channel selected to display on the main display unit 275. The TV controller 750 in the TV receiver unit 700 controls, according to the instruction, the UHF and VHF VCOs 715 and 716 and the IF signal processor 725 provided in the tuner 710 to tune in to the channel selected to display on the main display unit 275 and demodulate a TV broadcast signal on the selected channel into an image signal (S110). The decoder 730 decodes the demodulated image signal into a digital YUV signal.

The digital YUV signal is input to a signal converter 3211 in the signal processor unit 300 through the bus. The signal converter 3211 converts an interlaced-scan image signal inputted under the control of the controller 310 into a progressive scan image signal. A scaler 3213 in the signal processor unit 300 scales the converted image signal through interpolation and/or decimation to suit the resolution of the main display unit 275 (S120).

The scaled image signal is selectively subjected to brightness/contrast adjustment, image quality enhancement, etc., and is output from the image processor 321 to the first image output portion 3231 in the image output portion 323. In an embodiment, the image processor 321 writes completely processed image data into a frame memory area for the main display unit 275, and the first image output portion 3231 accesses the frame memory area to acquire data for display on the main display unit 275. The first image output portion 3231 then converts the image signal received from the image processor 321 into 16-bit RGB format suitable for input to the main display unit 275, and provides the 16-bit RGB image signal to the main display unit 275. The first image output portion 3231 sequentially writes display data into a display memory provided in the display driver 271 through a 16-bit parallel bus, thereby allowing the image to be displayed on the main display unit 275 (S130).

After switching to I²C host mode, the controller 310 instructs the TV receiver unit 700 to tune in to the channel selected to display on the sub display unit 277. Alternatively, once the controller 310 sets a mode, the controller 310 or the TV controller 750 can control the TV receiver unit 700 to tune in to the selected channels in a time division manner. In this case, since the first setting of a mode for the tuning based on time division is made in the system controller 130, the claims of the present invention are intended to cover this modification.

The TV controller 750 in the TV receiver unit 700 controls, according to the instruction, the UHF and VHF VCOs 715 and 716 and the IF signal processor 725 in the tuner 710 to tune in to the channel selected to display on the sub display unit 277 and demodulate a TV broadcast signal on the selected channel into an image signal (S140). The decoder 730 decodes the demodulated image signal into a digital YUV signal.

The digital YUV signal is input to the signal converter 3211 in the signal processor unit 300 through the bus. The signal converter 3211 converts an interlaced-scan image signal inputted under the control of the controller 310 into a progressive scan image signal. The scaler 3213 in the signal processor unit 300 scales the converted image signal through interpolation and/or decimation to suit the resolution of the sub display unit 277. Further, the scaled image signal is subjected to a vertical image reversal process in an image reversal portion 3215 provided in the signal processor unit 300 so that a vertically reversed image is displayed on the sub display unit 277 (S150). Accordingly, a user can view an image through the main display unit 275, while another user can view the image through the sub display unit 277.

After the image signal is selectively subjected to brightness/contrast adjustment, image quality enhancement, etc., it is output from the image processor 321 to the second image output portion 3233 in the image output portion 323. In an embodiment, the image processor 321 writes completely processed image data into a frame memory area for the sub display unit 277, and the second image output portion 3233 accesses the frame memory area to acquire data for display on the sub display unit 277. The second image output portion 3233 then converts the image signal received from the image processor 321 into 16-bit RGB format suitable for input to the sub display unit 277, and provides the 16-bit RGB image signal to the sub display unit 277. The second image output portion 3233 sequentially writes display data into a display memory provided in the display driver 273 through a 16-bit parallel bus, thereby allowing the image to be displayed on the sub display unit 277 (S160).

The image output portions 3231 and 3233 in the image output portion 323 can distinguish the display drivers 271 and 273 from each other through a memory map. Alternatively, the image output portions 3231 and 3233 can discriminate data for display on the display units 275 and 277 by selecting the corresponding individual memory chips through chip select logic.

An NTSC TV signal typically carries 60 fields or 30 frames per second. However, in the case of LCDs, a frame rate of about 24 frames per second is enough to appear as a continuous image to naked eyes. In a tuning method based on time division, during the first 24 frames, the controller 310 in the signal processor unit 300 controls the tuner 710 in the TV receiver unit 700 to tune in to a main display channel selected to display on the main display unit 275, and controls the image processor 321 and the image output portion 323 to display a TV image received through the main display channel on the main display unit 275. During the next 6 frames, the controller 310 in the signal processor unit 300 controls the tuner 710 in the TV receiver unit 700 to tune in to a sub display channel selected to display on the sub display unit 277, and controls the image processor 321 and the image output portion 323 to display a TV image received through the sub display channel on the sub display unit 277.

In another tuning method based on time division, during the first 4 of 5 consecutive frames, the controller 310 in the signal processor unit 300 controls the tuner 710 in the TV receiver unit 700 to tune in to a main display channel selected to display on the main display unit 275, and controls the image processor 321 and the image output portion 323 to display a TV image received through the main display channel on the main display unit 275. During the next 1 frame, the controller 310 in the signal processor unit 300 controls the tuner 710 in the TV receiver unit 700 to tune in to a sub display channel selected to display on the sub display unit 277, and controls the image processor 321 and the image output portion 323 to display a TV image received through the sub display channel on the sub display unit 277. The tuning method based on time division is advantageous over the previous tuning method based on time division in that voice signals demodulated in the main display channel are reproduced more smoothly.

In accordance with another preferred embodiment of the present invention, the phone control unit 100 further includes a display interchange unit (not shown) for controlling the signal processor unit 300 to interchange images on the channels currently displayed on the main and sub display units 275 and 277 according to an instruction inputted through the keypad 250. This instruction is preferably input through a hotkey.

In a channel interchange method, the controller 310 in the signal processor unit 300 adjusts the times to tune the TV receiver unit 700 to two channels in a time division manner so as to interchange the channels currently displayed on the main and sub display units 275 and 277. In another channel interchange method, the controller 310 controls the tuning duration of each of the channels, during which the TV receiver unit 700 is tuned to two channels, and the image processor 321 performs operations required to interchange the channels currently displayed on the main and sub display units 275 and 277.

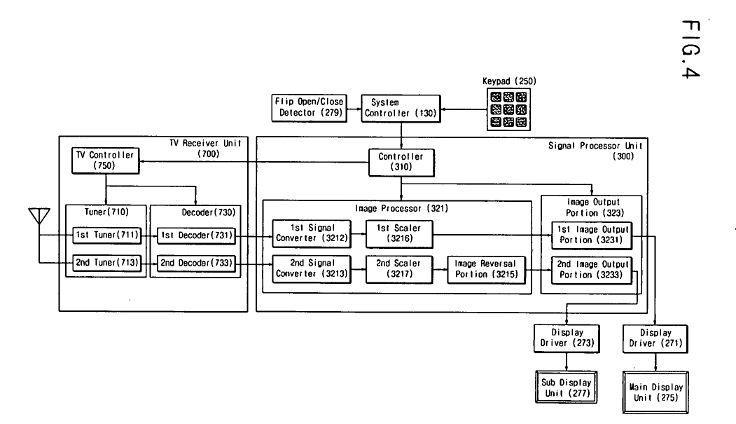

FIG. 4 is a block diagram showing a main part of the mobile terminal shown in FIG. 1 in accordance with another embodiment of the present invention. Although some of components shown in FIG. 1 have not been shown in FIG. 4, a description thereof is not deemed necessary for an understanding of the present embodiment. A TV receiver unit 700 includes first and second tuners 711 and 713. An image output portion 323 in a signal processor unit 300 includes a first image output portion 3231 for transferring an image signal outputted from the first tuner 711 to a main display unit 275, and a second image output portion 3233 for transferring an image signal outputted from the second tuner 713 to a sub display unit 277.

In accordance with another preferred embodiment of the present invention, the signal processor unit 300 further includes an image processor 321 for scaling an image signal outputted from the TV receiver unit 700 and transferring the scaled image signal to the second image output portion 3233.

In accordance with another preferred embodiment of the present invention, the system controller 130 controls the signal processor unit 300 to interchange images on the channels currently displayed on the main and sub display units 275 and 277 according to an instruction inputted through a keypad 250. In addition, the signal processor unit 300 controls the operation of the TV receiver unit 700 through a serial bus.

The configuration and operation of the mobile terminal in accordance with this embodiment will now be described in more detail with reference to FIG. 4.

The TV receiver unit 700 includes an antenna for receiving radio signals, a tuner 710 for demodulating wireless broadcast signals received through the antenna, a decoder 730 for decoding the demodulated broadcast signals into digital data, and a TV controller 750 for controlling the operation of the TV receiver unit 700 according to control instructions from the external devices. Here, the tuner 710 includes first and second tuners 711 and 713, and the decoder 730 includes first and second decoders 731 and 733. The decoder 730 may alternately receive and decode the demodulated signals from the first and second tuners 711 and 713, and sequentially output the decoded signals. The antenna of the TV receiver unit 700 may be provided separately from an antenna for mobile communications. Alternatively, a micro-strip patch antenna may be used for both TV reception and mobile communications.

The system controller 130 controls the first tuner 711 in the TV receiver unit 700 to tune in to a first channel, and controls the signal processor unit 300 to display an image on the first channel outputted from the first tuner 711 on the main display unit 275. The system controller 130 controls the second tuner 713 in the TV receiver unit 700 to tune in to a second channel, and controls the signal processor unit 300 to display an image on the second channel outputted from the second tuner 713 on the sub display unit 277.

Each of the first and second tuners 711 and 713 may be a conventional analog broadcast tuner which supports NTSC or PAL broadcast system, or a tuner commonly available in all of them. In another embodiment, each of the first and second tuners 711 and 713 may be a tuner which supports multimedia broadcast for mobile communications, such as wireless LAN based multimedia broadcast or satellite based DMB.

The signal processor unit 300 includes first and second signal converters 3212 and 3213, first and second scalers 3216 and 3217, an image reversal portion 3215, and first and second image output portions 3231 and 3233. The first signal converter 3212 converts an interlaced-scan image signal on the first channel, which is decoded by the first decoder 731, into a progressive scan image signal. The second signal converter 3213 converts an interlaced-scan image signal on the second channel, which is decoded by the second decoder 733, into a progressive scan image signal. The first scaler 3216 scales the image signal on the first channel converted by the first signal converter 3212 through interpolation and/or decimation to suit the resolution of the main display unit 275. The second scaler 3217 scales the image signal on the second channel converted by the second signal converter 3213 through interpolation and/or decimation to suit the resolution of the sub display unit 277. The image reversal portion 3215 performs a vertical image reversal process on the image signal scaled by the second scaler 3217. The first image output portion 3231 transfers the image signal on the first channel outputted from the first scaler 3216 to the display driver 271 used for the main display unit 275. The second image output portion 3233 transfers the image signal on the second channel processed by the image reversal portion 3215 to the display driver 273 used for the sub display unit 277.

The signal converters 3212 and 3213, the scalers 3216 and 3217, the image reversal portion 3215, and the image output portions 3231 and 3233 can be implemented with some memories and dedicated hardware or firmware known in the art, and various changes thereof in form and details may be made without departing from the scope and spirit of the present invention. For instance, it will be understood by those skilled in the art that the same process as described above can be performed by switching a converter and a scaler at high speed in synchronization with a field synchronization signal.

A detailed description will now be given of the operation of the mobile terminal in accordance with the embodiment of FIG. 4. First, when a user selects a TV mode and channels to view on the main and sub display units 275 and 277, the system controller 130 transfers the selected information to the signal processor unit 300 through the I²C bus. The controller 310 in the signal processor unit 300 receives the instruction, and controls the operations of the image processor 321, the image output portion 323 and the TV receiver unit 700 according to the received instruction.

On the other hand, the controller 310 switches the bus interface portion 353 from I²C slave mode to I²C host mode, and then instructs the TV receiver unit 700 to tune in to the selected channels. The TV controller 750 in the TV receiver unit 700 receives this instruction through a serial bus. The TV controller 750 controls the voltage-controlled oscillators and the IF signal processor in the first tuner 711 to tune in to the main display channel selected to display on the main display unit 275 and demodulate a TV broadcast signal on the main display channel into an image signal. In addition, the TV controller 750 controls the voltage-controlled oscillators and the IF signal processor in the second tuner 713 to tune in to the sub display channel selected to display on the sub display unit 277 and demodulate a TV broadcast signal on the sub display channel into an image signal.

In an embodiment, the decoder 730 decodes the demodulated image signal into a digital YUV signal in a time division manner. Since the decoder 730 performs a decoding operation using a matrix circuit after analog-to-digital conversion, it can decode received signals in a time division manner through a high-speed sampling operation. In another embodiment, each of the demodulated image signals can be decoded through the corresponding decoders 731 and 733.

The image signals outputted from the decoder 730 are transferred to the image processor 321 in the signal processor unit 300 through the bus. The first signal converter 3212 in the image processor 321 receives and converts an interlaced-scan image signal outputted from the first decoder 731 into a progressive scan image signal. The second signal converter 3213 in the image processor 321 receives and converts an interlaced-scan image signal outputted from the second decoder 733 into a progressive scan image signal. The first scaler 3216 in the image processor 321 scales the signal outputted from the first signal converter 3212 through interpolation and/or decimation to suit the resolution of the main display unit 275. The second scaler 3217 in the image processor 321 scales the signal outputted from the second signal converter 3213 through interpolation and/or decimation to suit the resolution of the sub display unit 277. The image reversal portion 3215 operates to perform a vertical image reversal process on the image signal outputted from the second scaler 3217 so that the image can be properly displayed on the sub display unit 277 with the flip opened.

The scaled image signals are output from the image processor 321 to the image output portion 323 after being subjected to brightness/contrast adjustment, image quality enhancement, etc.

In an embodiment, the image processor 321 writes image data for display on the main display unit 275 into a frame memory area allocated to the main display unit 275, and writes image data for display on the sub display unit 277 into a frame memory area allocated to the sub display unit 277. Here, the frame memory areas are distinguished from each other on a memory map. In another embodiment, a frame memory is allocated to each of the display units 275 and 277. The image processor 321 alternately accesses the frame memories through chip select logic.

The first image output portion 3231 in the image output portion 323 accesses the memory area allocated to the main display unit 275 to acquire image data for display on the main display unit 275. The first image output portion 3231 then converts the acquired image data into 16-bit RGB format suitable for input to the main display unit 275, and provides the 16-bit RGB image signal to the main display unit 275. The first image output portion 3231 sequentially writes display data into a display memory provided in the display driver 271 through a 16-bit parallel bus, thereby allowing the image to be displayed on the main display unit 275.

The second image output portion 3233 in the image output portion 323 accesses the memory area allocated to the sub display unit 277 to acquire image data for display on the sub display unit 277. The second image output portion 3233 then converts the acquired image data into 16-bit RGB format suitable for input to the sub display unit 277, and provides the 16-bit RGB image signal to the sub display unit 277. The second image output portion 3233 sequentially writes display data into a display memory provided in the display driver 273 through a 16-bit parallel bus, thereby allowing the image to be displayed on the sub display unit 277.

The image output portions 3231 and 3233 in the image output portion 323 can distinguish the display drivers 271 and 273 from each other through the memory map. Alternatively, the image output portions 3231 and 3233 can distinguish data for display on the display units 275 and 277 by selecting the corresponding individual memory chips through chip select logic.

In the embodiment of FIG. 4, since the TV receiver unit 700 includes a plurality of tuners (i.e., the first and second tuners 711 and 713 in the example of FIG. 4), the signal processor unit 300 can process the demodulated image signals in a time division manner to reproduce the demodulated image signals on the main and sub display units 275 and 277.

According to the present embodiment, the mobile terminal outputs voice signals demodulated by the first and second tuners 711 and 713 through different output means. That is, the mobile terminal outputs a voice signal demodulated by the first tuner 711 through a speaker, and outputs a voice signal demodulated by the second tuner 713 through a voice output circuit used for telephone communications.

The voice input/output circuit 210 includes an audio output circuit for outputting communication voice recovered by the RF module 230 under the control of the communication processor 110. The audio output circuit includes an earphone and a speaker for telephone communications. Audio signals outputted from the second tuner 713, which is responsible for demodulating an image signal for display on the sub display unit 277, are output from the voice input/output circuit 210 through the speaker or earphone. On the other hand, audio signals outputted from the first tuner 711, which is responsible for demodulating an image signal for display on the main display unit 275, are output from the audio output unit 220 which is responsible for outputting acoustic signals such as bell sounds.

In accordance with another preferred embodiment of the present invention, the phone control unit 100 further includes a display interchange unit (not shown) for controlling the signal processor unit 300 to interchange images on the channels currently displayed on the main and sub display units 275 and 277 according to an instruction inputted through the keypad 250. This instruction is preferably input through a hotkey. The channel interchange is performed under the control of the TV controller 750.

As apparent from the above description, the present invention provides a mobile terminal capable of receiving TV broadcasts, which has the following features and advantages.

The mobile terminal can display a received TV image on both main and sub display units.

The mobile terminal also allows users to watch different channels on the main and sub display units.

The mobile terminal also allows users to watch different channels on the main and sub display units with a single tuner, thereby simplifying hardware required for the mobile terminal and reducing manufacturing costs.

Furthermore, the mobile terminal includes a bus used for operation control in addition to a bus used for image processing. This makes it possible to systematically is control the mobile terminal and thus facilitates system design.

While the present invention has been described with reference to exemplary embodiments thereof, it will be understood by those skilled in the art that various changes in form and details may be made therein without departing from the scope of the present invention as defined by the following claims.

1. A mobile terminal comprising:
main and sub display units for displaying operating states;
a TV receiver unit for recovering an image signal from a TV signal received over the air; and
a signal processor unit for outputting the image signal from the TV receiver unit to the main display unit and the sub display unit selectively or simultaneously.

2. The mobile terminal of claim 1, further comprising:
a flip open/close detector for detecting whether a flip is opened or closed and outputting a flip open/close detection signal; and
a phone control unit for controlling the signal processor unit to output the image signal to the sub display unit located on the outer surface of the flip when the flip open/close detection signal indicates that the flip is closed.

3. The mobile terminal of claim 1, wherein the signal processor unit comprises an image processor for scaling an image signal outputted from the TV receiver unit and outputting the scaled image signal to the sub display unit.

4. The mobile terminal of claim 1, wherein the TV receiver unit comprises:
a tuner for demodulating a wireless broadcast signal received via an antenna; and
a decoder for decoding the demodulated wireless broadcast signal into digital data and outputting the digital data to the signal processor unit.

5. The mobile terminal of claim 4, wherein the signal processor unit controls the operation of the TV receiver unit through a serial bus.

6. The mobile terminal of claim 1,
wherein the TV receiver unit comprises first and second tuners, and
wherein the signal processor unit comprises a first image output portion for outputting an image signal outputted from the first tuner to the main display unit, and a second image output portion for outputting an image signal outputted from the second tuner to the sub display unit.

7. The mobile terminal of claim 6, wherein the signal processor unit further comprises an image processor for scaling an image signal outputted from the TV receiver unit and outputting the scaled image signal to the second image output portion.

8. The mobile terminal of claim 6, further comprising a system controller for controlling the signal processor unit to interchange respective images on two channels being currently displayed on the main and sub display units according to an instruction inputted through a keypad.

9. The mobile terminal of claim 6, wherein the signal processor unit controls the operation of the TV receiver unit through a serial bus.

10. The mobile terminal of claim 1, further comprising a system controller for controlling the TV receiver unit to tune in to first and second channels in a time division manner so that the TV receiver unit alternately outputs image signals on the first and second channels,
wherein the signal processor unit comprises:
a first image output portion for outputting an image signal on the first channel outputted from the TV receiver unit to the main display unit; and
a second image output portion for outputting an image signal on the second channel outputted from the TV receiver unit to the sub display unit.

11. The mobile terminal of claim 10, wherein the signal processor unit further comprises an image processor for scaling an image signal outputted from the TV receiver unit and outputting the scaled image signal to the second image output portion.

12. The mobile terminal of claim 10, further comprising a system controller for controlling the signal processor unit to interchange respective images on two channels being currently displayed on the main and sub display units according to an instruction inputted through a keypad.

13. The mobile terminal of claim 10, wherein the signal processor unit controls the operation of the TV receiver unit through a serial bus.
